(19) United States
(12) Patent Application Publication
(10) Pub. No.: US 2020/0332751 A1
(43) Pub. Date: Oct. 22, 2020

(54) PULSATION DAMPER USING SINGLE-SIDED DISK SPRING

(71) Applicant: Hyun Sik HWANG, Seoul (KR)

(72) Inventor: Hyun Sik HWANG, Seoul (KR)

(21) Appl. No.: 16/840,330

(22) Filed: Apr. 4, 2020

(30) Foreign Application Priority Data
Apr. 19, 2019 (KR) 10-2019-0046116

(51) Int. Cl. F02M 55/04; F02M 55/00

(52) U.S. Cl. CPC F02M 55/04; F02M 55/004

(57) ABSTRACT

Disclosed herein is a pulsation damper using a single-sided corrugated disk spring. In the pulsation damper using a single-sided corrugated disk spring, a section-expanded fuel rail inlet expanded to be equal to a section of a high-pressure fuel pipe is formed in an inlet-expanded fuel rail and a single-sided corrugated spring pulsation damper is attached to the inlet-expanded fuel rail, so that high-pressure fuel pump pulsating waves generated in the inlet-expanded fuel rail by a high-pressure fuel pump and injector pulsating waves generated in a fuel injector are mixed with each other and mixed pulsating waves generated in the inlet-expanded fuel rail are reduced.

### CROSS-REFERENCE TO RELATED APPLICATION

This application claims the benefit of Korean Patent Application No. 10-2019-0046116 filed on Apr. 19, 2019, which is hereby incorporated by reference herein in its entirety.

### BACKGROUND

### 1. Technical Field

The present invention relates to a pulsation damper using a single-sided disk spring.

### 2. Description of the Related Art

Vehicle gasoline engines are classified into multi-port injection (MPI) engines and gasoline direct injection (GDI) engines according to their fuel injection method.

GDI engines supply fuel, stored in a fuel tank, to an engine via a low-pressure fuel pump. The low-pressure fuel supplied to the engine is compressed to a high pressure by a high-pressure piston fuel pump and is supplied to a fuel injector via a high-pressure fuel pipe and a fuel rail.

The fuel injector of the GDI engine is configured to directly inject the high-pressure fuel, delivered under a high pressure, into the cylinder. The fuel of the GDI engine is formed into high-pressure and fine atomized particles by the fuel injector and injected directly into the engine cylinder. The fuel injected into the engine cylinder is ignited with an ignition plug and completely burnt. Accordingly, the GDI engine is an engine capable of preventing air pollution due to high-fuel combustion efficiency and the discharge of completely burnt exhaust gas.

Recently, a high-pressure GDI engine having a fuel pressure of 450 bar or more has been developed. The high-pressure GDI engine includes a high-pressure piston fuel pump, which is a high-pressure generator, a high-pressure fuel pipe, a fuel rail, and a fuel injector.

The high-pressure GDI engine is operated with a fuel pressure of about 45 bar in the case of low-speed and no-load operation, and is operated with a fuel pressure of 45 to 450 bar in the case of high-speed operation.

The above-described high-pressure GDI engine requires a high-pressure piston fuel pump having a fuel pressure fluctuation range of 10 times or more. High-pressure fuel is produced by the high-pressure piston fuel pump, and simultaneously high-pressure piston pump pulsating waves with large amplitude are generated. In addition, when high-pressure fuel is injected from the fuel injector, fuel injection pulsation waves are generated in the fuel rail.

Accordingly, mixed pulsation waves with large amplitude in which high-pressure piston fuel pump pulsating waves and fuel injection pulsation waves are mixed are generated in the fuel rail.

When large-amplitude pulsating waves are transmitted directly to the fuel injector, the amount of fuel injected changes instantaneously. Due to the change in the amount of fuel injected, fuel is combusted incompletely and the engine combustion efficiency is reduced due to the incomplete combustion. The engine exhaust gas is discharged into the atmosphere due to the incomplete combustion of fuel, which results in air pollution. The vibration and noise of the engine are caused by the mixed pulsating waves.

For the above reasons, there is required a wide-pressure range pulsation damper capable of reducing mixed pulsation waves in a wide pressure range.

Conventionally, high-pressure pulsation waves are reduced by installing an orifice at the fuel rail inlet. The pulsation damper using an orifice uses a method of reducing pulsating waves by rapidly reducing the fuel rail inlet to a size more than 1/10 times the cross-sectional area of the high-pressure fuel pipe to generate fuel flow and pressure resistance.

The above pulsation damping method using an orifice can reduce pump pulsating waves, but cannot reduce fuel injection pulsating waves generated in the fuel rail. In addition, the method using an orifice has a structure in which pump loss (the flow rate and pressure loss of the high-pressure piston fuel pump) is high due to the use of fuel resistance.

Furthermore, Korean Patent No. 10-1168591 discloses a pulsation damper using a disk spring. The pulsation damper uses a single disk spring, and has a disadvantage of insufficient performance in reducing pulsations in a wide pressure range such as pulsations in a pressure range in a GDI engine.

Furthermore, Korean Patent No. 10-1424994 is a pulsation damper using a composite disk spring. The pulsation damper reduces pulsations by connecting a piston to the composite spring. The pulsation damper is an indirect contact-type pulsation damper in which pulsating waves in fuel are transmitted to the composite spring through a piston.

The pulsation damper has a structure in which the pulsating waves in fuel come into contact with the piston and the pulsating waves do not come into direct contact with the composite spring. The pulsation damper has a drawback in that it is unable to reduce high-frequency pulsating waves in fuel, such as high-frequency pulsating waves in the fuel of a GDI engine, due to low reaction speed for high-frequency pulsating waves.

Moreover, Korean Patent No. 10-1873373 discloses a pulsation damper using a double-sided multi-layer corrugated spring. The pulsation damper reduces pulsations with a double-sided multi-layer corrugated spring. The pulsation damper uses the double-sided multi-layer corrugated spring, and thus has drawbacks in that it is difficult to apply to a narrow engine space and high manufacturing cost is incurred.

For the above reasons, there is required a pulsation damper having a light weight, a small volume, and a low manufacturing cost.

In order to solve the above problems, a pulsation damper using a single-sided disk spring has been invented.

In addition, as a conventional low-pressure pulsation damper using a single-layer double-sided corrugated spring, there is a damper for an MPI engine, which operates within a pressure range of 4.5 bar. This low-pressure damper has a drawback that it can reduce only about 4.5 bar fuel pulsating waves.

### SUMMARY

The present invention has been conceived to overcome the above-described problems, and an object of the present invention is to provide a pulsation damper using a single-sided disk spring, which is capable of reducing mixed pulsating waves, i.e., a mixture of high-pressure fuel pump pulsating waves and fuel injection pulsating waves present in fuel supplied to an inlet-expanded fuel rail.

An object of the present invention is to provide a pulsation damper using a single-sided disk spring, which is capable of improving vehicle fuel efficiency by increasing engine efficiency in such a manner as to remove the pressure and flow rate loss of a high-pressure piston fuel pump using an inlet-expanded fuel rail.

An object of the present invention is to provide a pulsation damper using a single-sided disk spring, which is capable of reducing the vibration and noise of an engine by reducing mixed pulsating waves present in high-pressure fuel.

An object of the present invention is to provide a pulsation damper using a single-sided disk spring, which is capable of reducing the fuel consumption of an engine, improving the output of the engine and completely burning fuel by allowing a fuel injector to perform multi-stage injection.

An object of the present invention is to provide a pulsation damper using a single-sided disk spring, which is capable of reducing harmful substances emitted through exhaust gas by completely combusting the fuel of an engine, thereby solving problems such as air pollution caused by a vehicle.

In order to accomplish at least any one of the above objects, the present invention provides a pulsation damper using a single-sided corrugated disk spring, wherein a section-expanded fuel rail inlet expanded to be equal to a section of a high-pressure fuel pipe is formed in an inlet-expanded fuel rail and a single-sided corrugated spring pulsation damper is attached to the inlet-expanded fuel rail, so that high-pressure fuel pump pulsating waves generated in the inlet-expanded fuel rail by a high-pressure fuel pump and injector pulsating waves generated in a fuel injector are mixed with each other and mixed pulsating waves generated in the inlet-expanded fuel rail are reduced.

The mixed pulsating waves generated in the inlet-expanded fuel rail may pass through a fuel rail fuel passage hole, a connector fuel passage and a damper fuel passage and reach a fuel chamber and the mixed pulsating waves having reached the fuel chamber may be reduced by a corrugated disk O-ring, a disk O-ring protection plate and a corrugated disk spring.

A corrugated disk spring fastening protrusion may be formed along the outer circumference of a corrugated disk spring, and a damper cover spring fastening depression formed in a pulsation damper cover may fasten the corrugated disk spring in conjunction with the corrugated disk spring fastening protrusion.

The disk O-ring protection plate may be disposed between the corrugated disk spring and the corrugated disk O-ring in order to protect the corrugated disk O-ring, and a disk O-ring protection protrusion is formed along an outer circumference of the disk O-ring protection plate in order to protect a corrugated disk O-ring outer circumference.

In order to accomplish at least any one of the above objects, the present invention provides an integrated pulsation damper using a single-sided corrugated disk spring, wherein the integrated pulsation damper, instead of a single-sided corrugated spring pulsation damper, is attached to an inlet-expanded fuel rail in which a section-expanded fuel rail inlet expanded to be equal to a section of a high-pressure fuel pipe is formed, so that high-pressure fuel pump pulsating waves generated in a high-pressure fuel pump and injector pulsating waves generated in a fuel injector are mixed with each other in the inlet-expanded fuel rail and mixed pulsating waves generated in the inlet-expanded fuel rail are reduced. An integrated damper bracket may be formed on an integrated damper body, and may be attached into the inlet-expanded fuel rail by integrated damper attachment surfaces.

The corrugated disk spring may be removed and a flat disk spring may be disposed at the same location, so that the mixed pulsating waves generated in the inlet-expanded fuel rail are reduced.

A flat disk spring fastening protrusion may be formed along the outer circumference of the flat disk spring, and a damper cover spring fastening depression formed in the pulsation damper cover may fasten the flat disk spring in conjunction with the flat disk spring fastening protrusion.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a diagram showing a state in which a pulsation damper according to an embodiment of the present invention is installed;

FIG. 2 is a longitudinal sectional perspective view showing the pulsation damper of FIG. 1;

FIG. 3 is a longitudinal sectional view showing the pulsation damper of FIG. 1;

FIG. 4 is an exploded perspective view showing the pulsation damper cover, damper body and connector of FIG. 1;

FIG. 5 is a longitudinal sectional perspective view showing a pulsation damper according to another embodiment of the present invention;

FIG. 6 is a longitudinal sectional view showing a pulsation damper according to still another embodiment of the present invention;

FIG. 7 is a longitudinal sectional view showing a pulsation damper according to still another embodiment of the present invention; and

FIG. 8 is an exploded perspective view of a flat disk spring.

### DETAILED DESCRIPTION

Embodiments of the present invention will be described in detail below with reference to the accompanying drawings so that those having ordinary skill in the art to which the present invention pertains can easily practice the present invention. However, the present invention may be implemented in various different forms, and is not limited to the embodiments described herein. Throughout the specification, like reference symbols are assigned to like components.

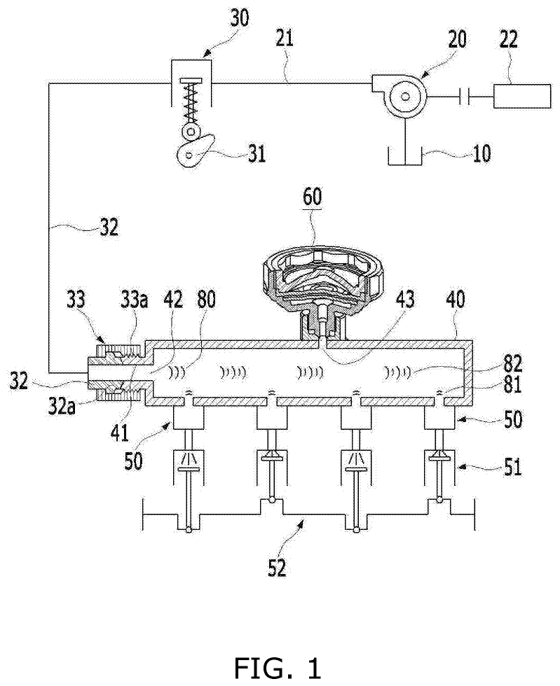

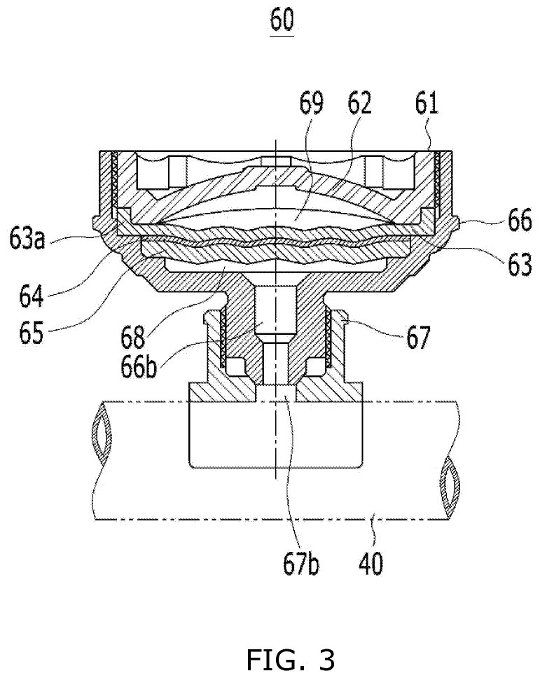

A pulsation damper according to an embodiment of the present invention will be described with reference to FIGS. 1 to 8.

FIG. 1 is a diagram showing a state in which a pulsation damper according to an embodiment of the present invention is installed. As shown in FIG. 1, with regard to a GDI engine, fuel stored in a vehicle fuel tank 10 is supplied to a vehicle engine at a low pressure (equal to or lower than 4.5 bar) by a low-pressure fuel pump 20. The low-pressure fuel supplied to the vehicle engine by the low-pressure fuel pump 20 is compressed to a high pressure (45 to 450 bar) by a high-pressure piston fuel pump 30, passes through a high-pressure fuel pipe 32, and is supplied to an inlet-expanded fuel rail 40.

In this case, the high-pressure fuel compressed to the high pressure is injected into an engine cylinder 51 by a fuel injector 50. The fuel injected into the engine cylinder 51 at a high pressure generates engine power through combustion and explosion processes via an ignition plug, and the engine power is transferred to an engine crankshaft 52 and drives a vehicle.

The fuel compressed to the high pressure by the high-pressure piston fuel pump 30 is supplied to the inlet-expanded fuel rail 40. The high-pressure fuel supplied to the inlet-expanded fuel rail 40 is accompanied by high-pressure fuel pump pulsating waves 80.

Furthermore, injector pulsating waves 81 are generated while the fuel injector 50 injects the high-pressure fuel into the engine cylinder 51. The high-pressure fuel pump pulsating waves 80 and the injector pulsating waves 81 generate mixed pulsating waves 82 within the inlet-expanded fuel rail 40.

The mixed pulsating waves 82 cause the incomplete combustion of the fuel inside the engine cylinder 51 by instantaneously changing the amount of fuel injected by the fuel injector 50, thus resulting in a reduction in engine output. Furthermore, exhaust gas discharged due to the incomplete combustion of the fuel causes air pollution. Moreover, the incomplete combustion of the fuel causes engine vibration and noise.

For the above-described reasons, there is required a high-pressure pulsation damper for reducing the high-pressure fuel pump pulsating waves 80, the injector pulsating waves 81 and the mixed pulsating waves 82 in the inlet-expanded fuel rail 40.

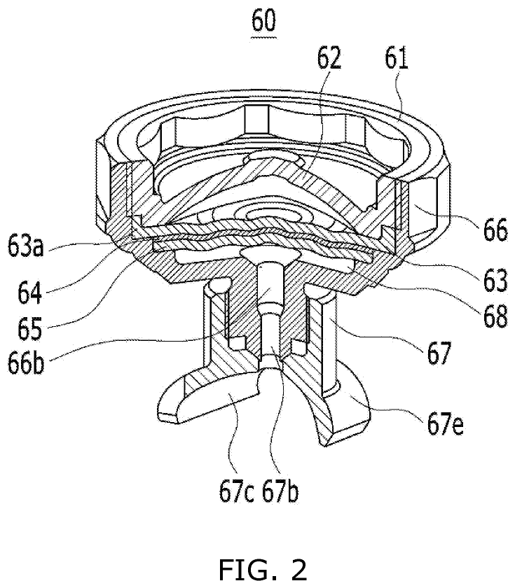

FIG. 2 is a longitudinal sectional perspective view showing the pulsation damper of FIG. 1. As shown in FIG. 2, the present invention provides the pulsation damper using a single-sided corrugated disk, which reduces the high-pressure fuel pump pulsating waves 80, the injector pulsating waves 81 and the mixed pulsating waves 82 in such a manner that the mixed pulsating waves 82 generated in the inlet-expanded fuel rail 40 pass through a fuel rail fuel passage hole 43, a connector fuel passage 67b and a damper fuel passage 66b and reach a fuel chamber 68 and the mixed pulsating waves 82 having reached the fuel chamber 68 are reduced by a corrugated disk O-ring 65, a disk O-ring protection plate 64 and a corrugated disk spring 63.

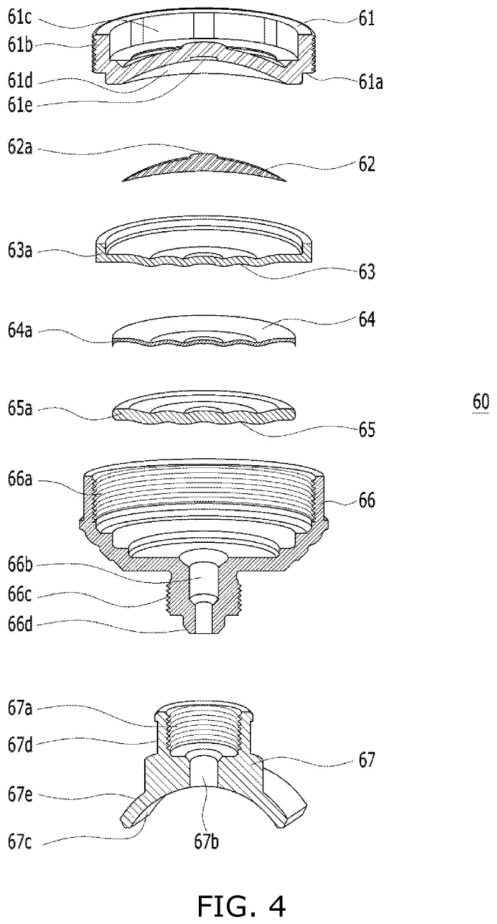

FIG. 4 is an exploded perspective view showing the pulsation damper cover, damper body and connector of FIG. 1. As shown in FIG. 4, there is shown the pulsation damper using a single-sided corrugated disk spring, which is configured such that a corrugated disk spring fastening protrusion 63a is formed along the outer circumference of a corrugated disk spring 63 and a damper cover spring fastening depression 61a formed in a pulsation damper cover 61 fastens the corrugated disk spring 63 in conjunction with the corrugated disk spring fastening protrusion 63a.

In FIG. 4, there is shown the pulsation damper using a single-sided corrugated disk spring, which is configured such that the disk O-ring protection plate 64 is disposed between the corrugated disk spring 63 and the corrugated disk O-ring 65 in order to protect the corrugated disk O-ring 65 and a disk O-ring protection protrusion 64a is formed along the outer circumference of the disk O-ring protection plate 64 in order to protect a corrugated disk O-ring outer circumference 65a.

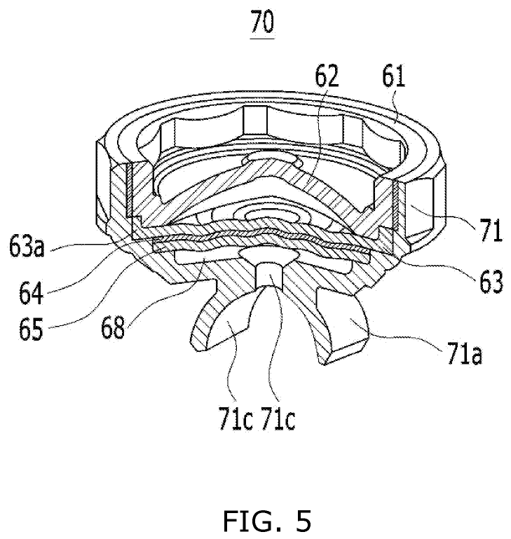

FIG. 5 is a longitudinal sectional perspective view showing a pulsation damper according to another embodiment of the present invention. As shown in FIG. 5, the present invention provides an integrated pulsation damper 70 using a single-sided corrugated disk spring, in which an integrated damper bracket 71a is formed on an integrated damper body 71.

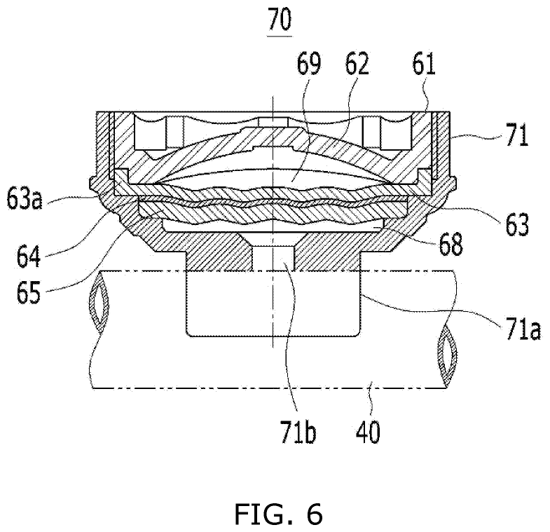

FIG. 6 is a longitudinal sectional view showing a pulsation damper according to still another embodiment of the present invention. As shown in FIG. 6, the present invention provides an integrated pulsation damper 70 using a single-sided corrugated disk spring, which is configured such that the integrated pulsation damper 70, instead of the single-sided corrugated spring pulsation damper 60, is attached to an inlet-expanded fuel rail 40 in which a section-expanded fuel rail inlet 42 expanded to be equal to the section of a high-pressure fuel pipe 32 is formed, so that high-pressure fuel pump pulsating waves 80 generated in a high-pressure fuel pump and injector pulsating waves 81 generated in a fuel injector 50 are mixed with each other in the inlet-expanded fuel rail 40 and mixed pulsating waves 82 generated in the inlet-expanded fuel rail 40 are reduced.

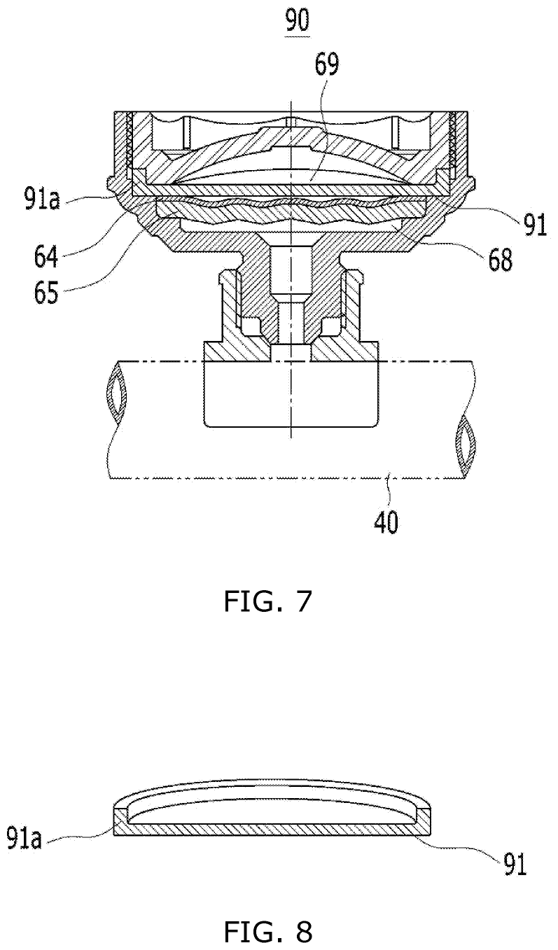

FIG. 7 is a longitudinal sectional view showing a pulsation damper according to still another embodiment of the present invention. As shown in FIG. 7, there is disclosed a flat disk spring pulsation damper 90 using a single-sided flat disk spring, which is configured such that the corrugated disk spring 63 is removed and a flat disk spring 91 is disposed at the same location, so that the mixed pulsating waves 82 generated in the inlet-expanded fuel rail 40 are reduced. In FIG. 7, there is shown the flat disk spring pulsation damper 90 using a single-sided flat disk spring, in which a flat disk spring fastening protrusion 91a is formed along the outer circumference of the flat disk spring 91 and a damper cover spring fastening depression 61a formed in the pulsation damper cover 61 fastens the flat disk spring 91 in conjunction with the flat disk spring fastening protrusion 91a.

In the pulsation damper using a single-sided disk spring according to an embodiment of the present invention, the sectional area of the fuel rail inlet is made equal to the sectional area of the high-pressure fuel pipe coupled to the inlet-expanded fuel rail and the pulsation damper is installed in the inlet-expanded fuel rail from which a reduced section orifice is removed. The mixed pulsation waves in which the pump pulsation waves generated in the high-pressure piston fuel pump of the GDI engine and the fuel injection pulsation waves generated in the fuel injection injector are mixed together are reduced by the pulsation damper using a single-sided disk spring. Accordingly, it may be possible to obtain the pulsation damper without the pressure and flow rate loss of fuel supplied by driving the high-pressure piston fuel pump.

According to an embodiment of the present invention, the pulsation damper is installed in the inlet-expanded fuel rail from which the orifice is removed, so that mixed pulsation waves present in the inlet-expanded fuel rail are reduced and thus an effect is achieved in that the noise and vibration of an engine are reduced due to the reduction in the mixed pulsation waves.

According to an embodiment of the present invention, multi-stage injection may be performed to allow 2 to 5 injections per cycle when fuel is injected into an engine cylinder due to the removal of mixed pulsation waves in fuel. Since the fuel is completely burned by the above multi-stage fuel injection, there is achieved the effect of improving engine combustion efficiency. In addition, it may be possible to reduce particle mass (PM) and the number of particles (PN), which are subject to engine exhaust gas regulations.

Although the specific embodiments of the present invention have been disclosed for illustrative purposes, those skilled in the art will appreciate that various modifications, additions and substitutions are possible without departing from the scope and spirit of the invention as disclosed in the accompanying claims.

What is claimed is:

1. A pulsation damper using a single-sided corrugated disk spring, wherein a section-expanded fuel rail inlet expanded to be equal to a section of a high-pressure fuel pipe is formed in an inlet-expanded fuel rail and a single-sided corrugated spring pulsation damper is attached to the inlet-expanded fuel rail, so that high-pressure fuel pump pulsating waves generated in the inlet-expanded fuel rail by a high-pressure fuel pump and injector pulsating waves generated in a fuel injector are mixed with each other and mixed pulsating waves generated in the inlet-expanded fuel rail are reduced.

2. The pulsation damper of claim 1, wherein the mixed pulsating waves generated in the inlet-expanded fuel rail pass through a fuel rail fuel passage hole, a connector fuel passage and a damper fuel passage and reach a fuel chamber and the mixed pulsating waves having reached the fuel chamber are reduced by a corrugated disk O-ring, a disk O-ring protection plate and a corrugated disk spring.

3. The pulsation damper of claim 2, wherein a corrugated disk spring fastening protrusion is formed along an outer circumference of a corrugated disk spring, and a damper cover spring fastening depression formed in a pulsation damper cover fastens the corrugated disk spring in conjunction with the corrugated disk spring fastening protrusion.

4. The pulsation damper of claim 3, wherein the disk O-ring protection plate is disposed between the corrugated disk spring and the corrugated disk O-ring in order to protect the corrugated disk O-ring, and a disk O-ring protection protrusion is formed along an outer circumference of the disk O-ring protection plate in order to protect a corrugated disk O-ring outer circumference.

5. An integrated pulsation damper using a single-sided corrugated disk spring, wherein the integrated pulsation damper, instead of a single-sided corrugated spring pulsation damper, is attached to an inlet-expanded fuel rail in which a section-expanded fuel rail inlet expanded to be equal to a section of a high-pressure fuel pipe is formed, so that high-pressure fuel pump pulsating waves generated in a high-pressure fuel pump and injector pulsating waves generated in a fuel injector are mixed with each other in the inlet-expanded fuel rail and mixed pulsating waves generated in the inlet-expanded fuel rail are reduced.

6. The integrated pulsation damper of claim 5, wherein an integrated damper bracket is formed on an integrated damper body and is attached into the inlet-expanded fuel rail by integrated damper attachment surfaces.

7. The pulsation damper of claim 2, wherein the corrugated disk spring is removed and a flat disk spring is disposed at a same location, so that the mixed pulsating waves 82 generated in the inlet-expanded fuel rail are reduced.

8. The pulsation damper of claim 7, wherein a flat disk spring fastening protrusion is formed along an outer circumference of the flat disk spring, and a damper cover spring fastening depression formed in the pulsation damper cover fastens the flat disk spring in conjunction with the flat disk spring fastening protrusion.
